(19) United States
(12) Patent Application Publication
(10) Pub. No.: US 2017/0292316 A1
(43) Pub. Date: Oct. 12, 2017

(54) AN INK-STAINING ANTI-THEFT CASH BOX

(71) Applicant: INTERNATIONAL CURRENCY TECHNOLOGIES CORPORATION, Taipei (TW)

(72) Inventors: Chia-Min CHANG, Taipei (TW); Hung-Yi CHANG, Taipei (TW); Chia-Hung HU, Taipei (TW); Yi-Hsin CHEN, Taipei (TW); Chen-Feng HUANG, Taipei (TW)

(21) Appl. No.: 15/202,872

(22) Filed: Jul. 6, 2016

(30) Foreign Application Priority Data
Apr. 8, 2016 (TW) 105111057

(51) Int. Cl. E05G 1/12; E05G 1/00; G07D 11/00; E05G 1/024

(52) U.S. Cl. CPC E05G 1/12; E05G 1/024; E05G 1/005; G07D 11/0009; E05Y 2800/426

(57) ABSTRACT

An ink-staining anti-theft cash box includes cash box mounted mainframe of bill acceptor, automatic vending machine or service kiosk and defining accommodation chamber, front opening and top mounting hole, ink cartridge including cartridge body mounted top mounting hole of mainframe, a plurality of ink holders accommodated cartridge body and actuator adapted for triggering ink holders, anti-theft security module with trigger unit mounted cash box, locking mechanism including control unit and operating unit operable drive control unit in locking or unlocking trigger unit. If cash box removed from mainframe by force without unlocking locking mechanism according normal unlocking procedure, trigger unit of anti-theft security module trigger actuator of ink cartridge, forcing respective ink holders to ink-stain storage bills in box body with unfading ink, causing bills lose their market value or transaction capabilities, deterring criminals to limit their criminal acts and enhancing security level of cash box.

### BACKGROUND OF THE INVENTION

This application claims the priority benefit of Taiwan patent application number 105111057, filed on Apr. 08, 2016.

### 1. Field of the Invention

The present invention relates to bill acceptor technology and more particularly, to an ink-staining anti-theft cash box, which utilizes an anti-theft security module to detect the connection relationship between the cash box and the mainframe, enabling an ink cartridge to be triggered to ink-stain bills in the cash box if the cash box is separated from the mainframe without through the normal unlocking procedure, deterring criminals to limit their criminal acts and enhancing the security level of the cash box.

### 2. Description of the Related Art

Following fast development of modern technology, convenience and rapidness have become important factors in our modern daily life. Nowadays, different automatic vending machines, card dispensers, ticket machines and bill exchange machines are used everywhere to sell different products without serviceman. These machines are highly appreciated for the advantage of saving much labor and bringing convenience to people.

For the advantages of scientific intelligence, quick service, and quick finish of payment, Q-shop breaks through the conventional sales and marketing barriers. A Q-shop may provide automatic vending machines for vending drinks, cigarettes, tickets, ice cream, memorial coins, key rings, or even hamburgers and noodles. Nowadays, many virtual shops are established to make online shopping, allowing consumers to personally experience self-service shopping, billing and payment process and to change the shopping habits and consumption patterns, and creating a variety of different patterns of new business operating model to achieve closer to the consumer's shopping lifestyle

However, these machines normally run with no staff present (unattended) except the very short time period in which staffs fill up the machines with new supplies. An evil person may take bills, coins, stored value cards, tickets and other selling items from these unattended machines illegally. For example, an evil person may insert a cord attached bill into the bill slot of a vending machine to buy one selling item and then take up the cord to pull back the bill after getting the commodity. In order to prohibit an evil person from pulling back an inserted bill after trading, a vending machine may provide an anti-theft hook at the back side of the identify recognition device. Thus, a transaction can be executed only after the inserted bill has been verified and moved over the anti-theft hook. Further, a backstop device can be used in an automatic vending machine for lacerating a Mylar strip or plastic strip that is attached to an inserted bill, separating the inserted bill from the attached cord and preventing the cord from pulling back the bill.

Further, a criminal may use a tool, utensil or cutting device to destroy an automatic vending machine. The bill acceptors of conventional automatic vending machines are normally not equipped with a lock. Even a bill acceptor of an automatic vending machine is equipped with a lock, it can easily be destroyed, allowing the cash box to be removed from the bill acceptor without through a normal unlocking procedure. The bills stolen from the cash box of an automatic vending machine can still be effectively circulated in the market, causing the automatic vending machine owner to suffer a great loss. Further, the police are a lot harder to find and trace the stolen bills and to quickly crack the criminal case.

Therefore, it is desirable to provide an anti-theft cash box for automatic vending machine, which can effectively deter criminals to limit their criminal acts and significantly enhance the security level of the cash box.

### SUMMARY OF THE INVENTION

The present invention has been accomplished under the circumstances in view. It is therefore one object of the present invention to provide an ink-staining anti-theft cash box, which comprises a cash box mounted in a mainframe of a bill acceptor, automatic vending machine or service kiosk and defining an accommodation chamber, a front opening and a top mounting hole, an ink cartridge, which comprises a cartridge body mounted in the top mounting hole of the mainframe, a plurality of ink holders accommodated in the cartridge body and an actuator adapted for triggering the ink holders, an anti-theft security module, which comprises a trigger unit mounted in the cash box, and a locking mechanism, which comprises a control unit and an operating unit operable to drive the control unit in locking or unlocking the trigger unit. If the cash box is removed from mainframe by force without unlocking the locking mechanism according to the normal unlocking procedure, the trigger unit of the anti-theft security module will trigger the actuator of the ink cartridge, forcing the respective ink holders to ink-stain the storage bills in the box body with an unfading ink, causing the bills to lose their market value or transaction capabilities, deterring criminals to limit their criminal acts and enhancing the security level of the cash box.

According to another aspect of the present invention, the box body of the cash box further comprises a retaining unit. When mounting the cash box in the mainframe, attach the box body to the back side of the housing of the mainframe to insert retaining rods of the retaining unit into respective insertion grooves of respective retaining grooves of the housing of the mainframe and to abut respective mating walls of the box body against respective joining surfaces at two lateral walls of the housing of the mainframe, and then move the box body upwards to engage the retaining rods of the retaining unit into respective engagement grooves of the respective retaining grooves. Further, the anti-theft security module comprises a trigger unit. After abutment of the mating walls of the box body against the respective joining surfaces of the housing of the mainframe, detection elements of a trigger unit of the anti-theft security module are stopped by the joining surfaces, links of the trigger unit are forced to hold an interlocking device in place, preventing the interlocking device from being pulled by tension springs to move a trigger plate away from the actuator, and thus, impactors of the actuator are prohibited from forcing the ink holders to eject the unfading ink when the detection elements are released from the constraint of the joining surfaces. Further, the locking mechanism comprises a control unit, and an operating unit operable to drive the control unit in locking or unlocking the trigger unit. If the cash box is removed from mainframe by force without unlocking the locking mechanism according to the normal unlocking procedure, the trigger unit of the anti-theft security module will trigger the actuator of the ink cartridge, forcing the respective ink holders to ink-stain the storage bills in the box body with an unfading ink. Further, the box body comprises an axle transversely disposed in a bottom side of the opening, and a frame-shaped door panel pivotally coupled to the axle for stopping the pressure plate in place and movable to close or open the opening. The direction in opening the frame-shaped door panel from the opening is same as the direction in mounting the cash box in the housing of the mainframe. Further, the cash box comprises a metal shielding shell fixedly fastened to the mating walls of the box body to surround the box body. Thus, the cash box has no apparent outer weakness, increasing the difficulty in stealing or destroying the cash box and providing enhanced security.

According to still another aspect of the present invention, if a criminal destroys the cash box or removes it from the mainframe without unlocking the locking mechanism, the detection elements of the trigger unit of the anti-theft security module will be triggered, enabling the tension springs to pull the interlocking device downwardly toward the control unit, leading to separation between the trigger plate and the actuator, and the impactors of the actuator will be immediately forced by the associated springs to pierce into or to lacerate the respective ink holders, causing the unfading ink to be ejected out of the respective ink holders through ink supply channels toward the inside of the accommodation chamber of the box body to ink-stain the storage bills over at least one corner of each storage bill. Further, the ink outlets of the ink supply channels of the ink cartridge are arranged in a staggered manner so that the unfading ink of the ink holders can be evenly ejected over any amount of storage bills in the box body to ink-stain at least one corner of each storage bill. Further, each ink holder comprises an elongated holder body made of glass or a plastic film with the unfading ink filled therein. Thus, the ink holders of the ink cartridge are replaceable. Further, the impactors and springs of the actuator can be mounted to match with the trigger plate of the trigger unit, enabling the anti-theft function of the cash box to be reset.

According to still another aspect of the present invention, the operating unit of the locking mechanism comprises a combination lock, an interlocking mechanism and a subsidiary lock. When the site manager is going to unlock the cash box or to remove the cash box from the mainframe, the site manager needs to unlock the combination lock at first, and then to rotate the rotating discs of the combination lock, enabling the rotating discs to show the correct combination. Because the combination lock is controlled by the interlocking mechanism and the subsidiary lock, it is necessary to unlock the combination lock and then to unlock the subsidiary lock so that the operating unit can be operated to move the swinging arm of the control unit into abutment against the interlocking device of the trigger unit of the anti-theft security module, prohibiting the tension springs from pulling the interlocking device and preventing disengagement of the trigger plate from the impactors of the actuator to trigger the ink holders of the ink cartridge in ejecting the unfading ink. On the contrary, if the subsidiary lock is locked, the swinging arm of the control unit will be forced by the operating unit to move away from the interlocking device of the trigger unit, allowing the trigger plate to be pulled downwards away from the impactors of the actuator by the tension springs, and thus, the ink holders will be triggered to eject the unfading ink. Because the combination lock and the subsidiary lock are interlocked, removing the cash box from the mainframe requires an unlocking procedure and the use of a key. Therefore, the invention significantly increases the difficulty in stealing or destroying the cash box, and provides enhanced security.

According to still another aspect of the present invention, the subsidiary lock comprises an actuation portion, and a guide plate movable by the actuation portion; the locking mechanism further comprises a locking unit, which comprises a pinch plate mounted at the guide plate of the subsidiary lock, and a guide wheel pivotally mounted on the pinch plate and drivable by the guide plate to move the pinch plate into the mainframe. When the cash box is mounted in the mainframe, the retaining unit of the box body is engaged into the retaining groove of the housing. When inserting the key into the actuation portion of the subsidiary lock and then rotating the key, the actuation portion will be driven to bias the guide plate, causing the pinch plate to be forced by the guide wheel into engagement with the insertion groove of the retaining groove to lock the box body to the housing. Because the pinch plate of the locking unit is linked to the subsidiary lock of the operating unit, the invention prevents the user from dismounting the cash box without unlocking the locking unit to cause a false triggering of the anti-theft security module and also relatively increases the difficulty in stealing the cash box.

According to still another aspect of the present invention, the locking unit of the locking mechanism further comprises an anti-trigger baffle plate disposed above the pinch plate. The anti-trigger baffle plate comprises a pushing portion and an opposing engagement portion. When the site manager removes the cash box from the mainframe after unlocked the locking mechanism, the pushing portion of the anti-trigger baffle plate of the locking unit is released from the constraint of the joining surfaces of the lateral walls of the housing and driven by the torsion spring to turn out of the through hole of the mating wall of the box body, and the engagement portion of the anti-trigger baffle plate is biased downwardly to a lower limit position. When locking the subsidiary lock at this time, the second link of the interlocking mechanism will be moved to abut the stepped abutment surface thereof against the engagement portion of the anti-trigger baffle plate and to prohibit the subsidiary lock from being locked, avoiding locking the operating unit to trigger the anti-theft security module as the site manager is taking the cash box out of the mainframe and preventing a false triggering of the ink cartridge to ink-stain the storage bills in the cash box. On the contrary, when the cash box is mounted in the mainframe, the pushing portion of the anti-trigger baffle plate will be stopped against the joining surface of the associated lateral wall of the housing and moved back to its original position to keep the engagement portion away from the second link of the interlocking mechanism. At this time, the subsidiary lock can be locked, allowing operation of the operating unit to move the control unit in enabling the anti-theft function of the anti-theft security module.

### BRIEF DESCRIPTION OF THE DRAWINGS

FIG. 1 is an oblique top elevational view of an ink-staining anti-theft cash box in accordance with the present invention.

FIG. 2 is an exploded view of the ink-staining anti-theft cash box shown in FIG. 1.

FIG. 3 corresponds to FIG. 2 when viewed from another angle.

FIG. 4 is an exploded view illustrating the relationship between the ink-staining anti-theft cash box of the present invention and a mainframe.

FIG. 5 is a schematic side view illustrating the ink-staining anti-theft cash box of the present invention mounted in the mainframe.

FIG. 6 is an elevational view of a part of the present invention, illustrating the anti-theft security module triggered after removal of the ink-staining anti-theft cash box from the mainframe.

FIG. 7 is a schematic top view of a part of the present invention, illustrating a status of the ink cartridge before ink injection.

FIG. 8 is a schematic sectional side view of a part of the present invention, illustrating an ink ejected out of the ink cartridge onto the storage bills.

FIG. 9 is a schematic front view of the present invention, illustrating a status of the cash box before unlocking.

FIG. 10 is a schematic front view of the present invention, illustrating a status of the cash box during the unlocking operation.

FIG. 11 is a schematic side view of the present invention, illustrating the cash box unlocked.

FIG. 12 is an oblique top elevational view of the present invention, illustrating the frame-shaped door panel of the cash box opened.

### DETAILED DESCRIPTION OF THE PREFERRED EMBODIMENT

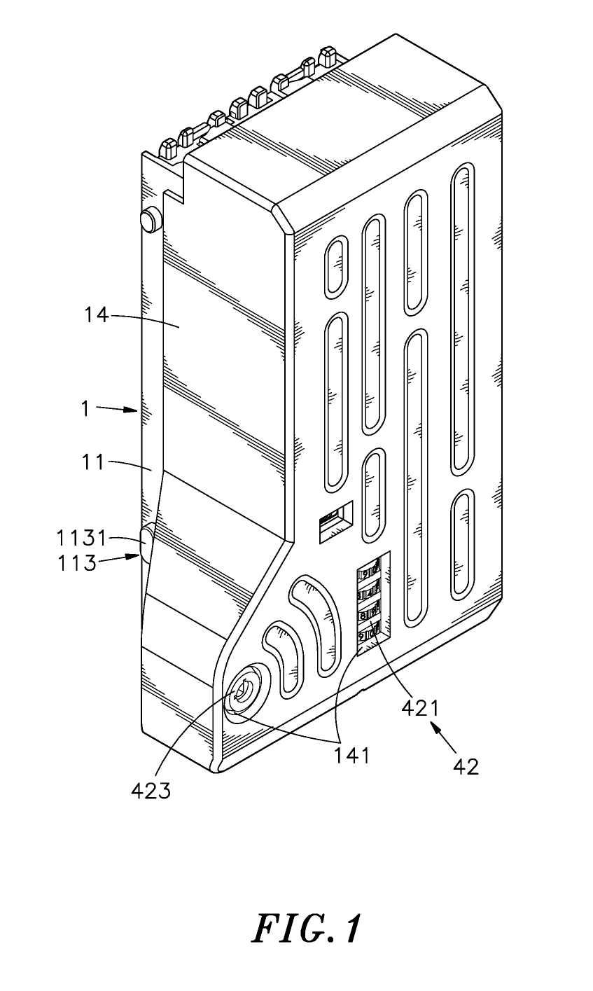

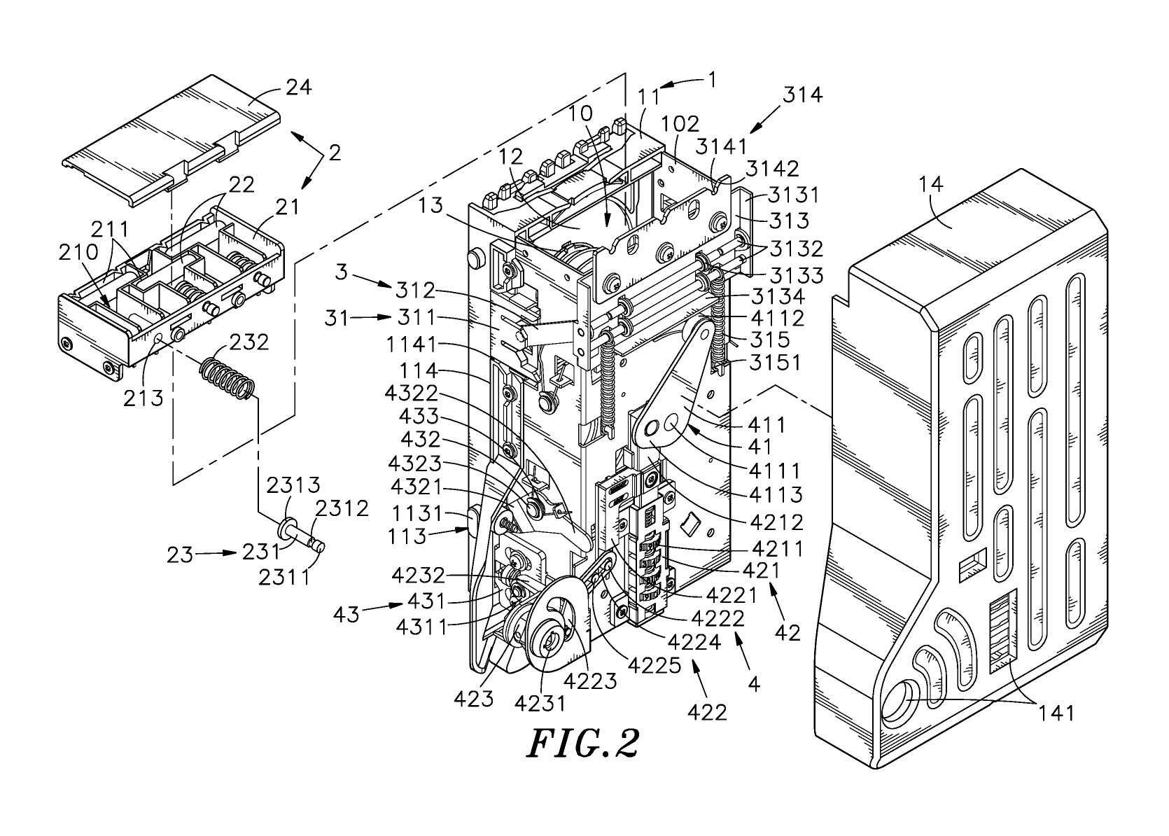

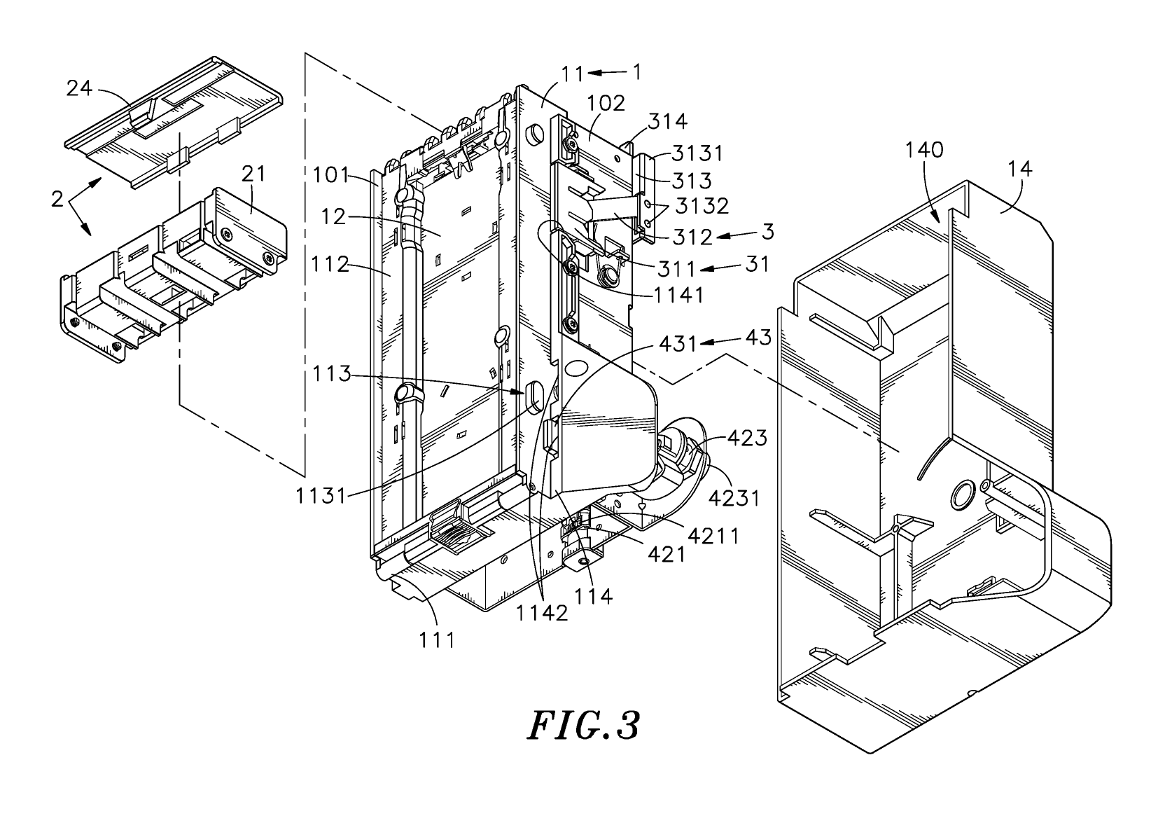

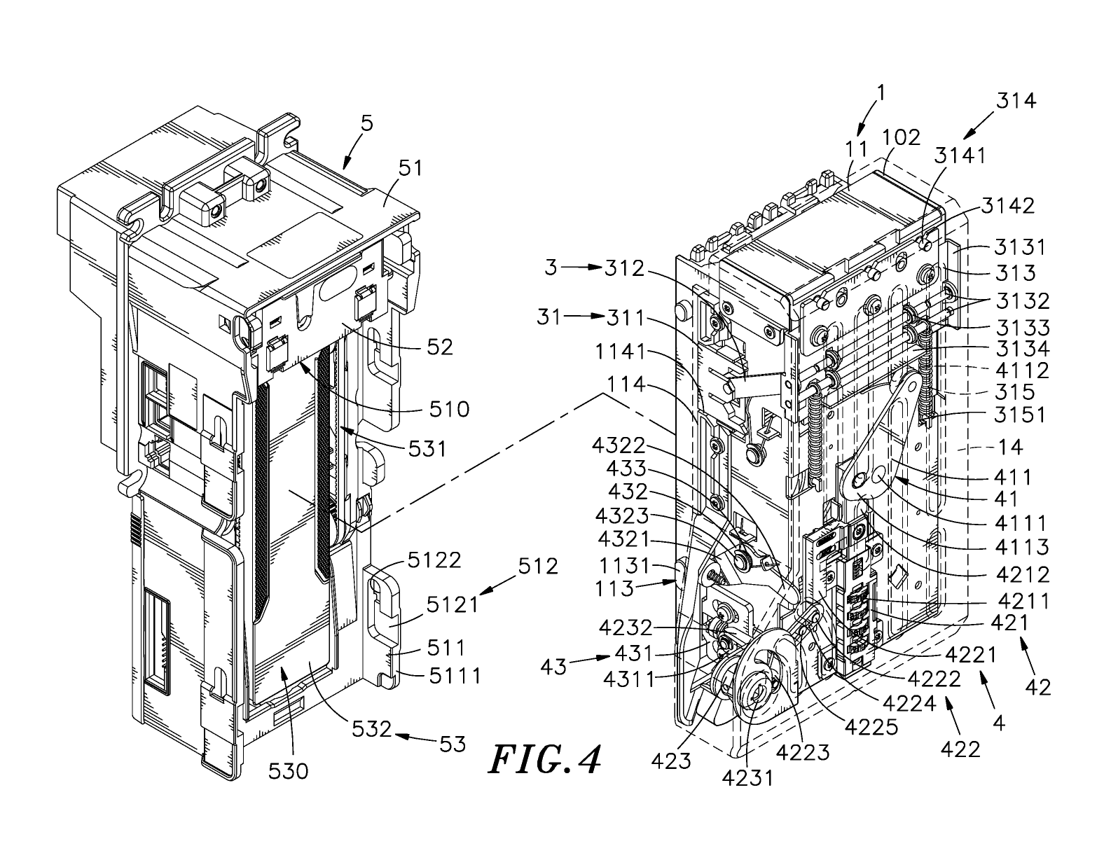

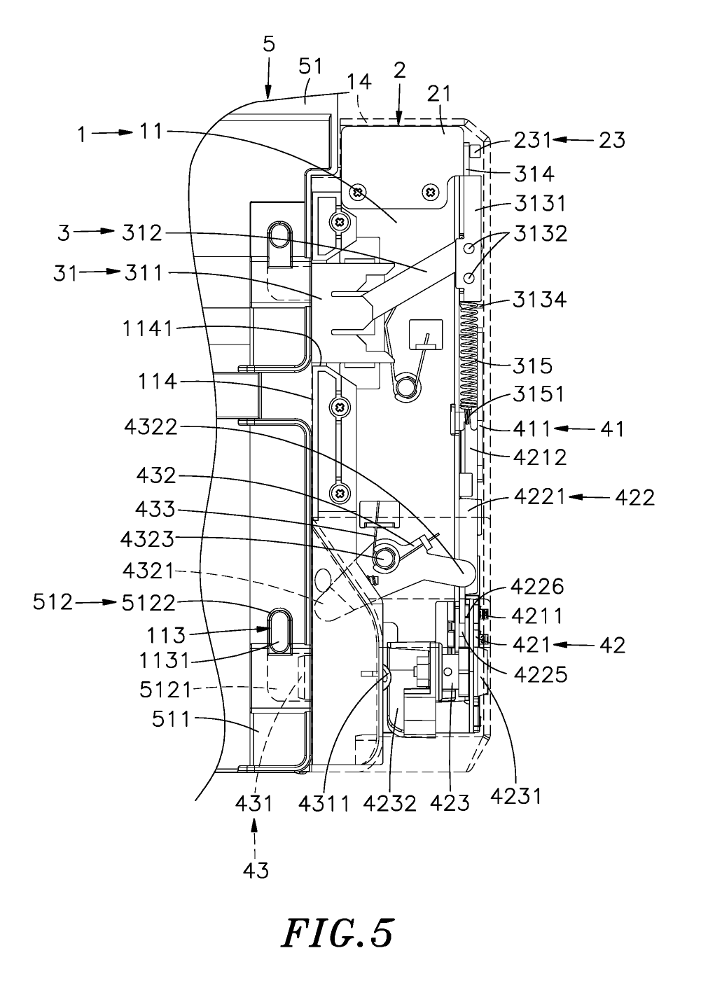

Referring to FIGS. 1-5, an ink-staining anti-theft cash box in accordance with the present invention is shown. The ink-staining anti-theft cash box comprises a cash box 1, an ink cartridge 2, an anti-theft security module 3 and a locking mechanism 4.

The cash box 1 comprises a box body 11, a pressure plate 12, a plurality of elastic members 13, and a metal shielding shell 14. The box body 11 comprises an accommodation chamber 10, an opening 101 defined in a front side thereof in communication between the accommodation chamber 10 and the atmosphere, an axle 111 transversely disposed in a bottom side of the opening 101, a frame-shaped door panel 112 pivotally coupled to the axle 111 and movable to close or open the opening 101, a retaining unit 113 comprising a plurality of retaining rods 1131 vertically spaced along two opposite lateral sides of the opening 101, a mounting hole 102 located in a top side thereof in communication with the accommodation chamber 10, and two mating walls 114 respectively extended from two opposite sidewalls thereof adjacent to the retaining unit 113. Each mating wall 114 defines therein a transverse sliding groove 1141 and at least one through hole 1142 spaced below the at least one transverse sliding groove 1141.

The pressure plate 12 is accommodated in the accommodation chamber 10 and stoppable against a back side of the frame-shaped door panel 112. The elastic members 13 are mounted in a bottom side of the accommodation chamber 10 of the box body 11 and stopped against the pressure plate 12, forcing the pressure plate 12 to stop against the back side of the frame-shaped door panel 112. The metal shielding shell 14 is fixedly fastened to the mating walls 114 of the box body 11 with screws to surround the box body 11 beyond the opening 101 with a positioning space 140 defined between the shielding shell 14 and the box body 11. Further, the shielding shell 14 comprises a plurality of slots 141.

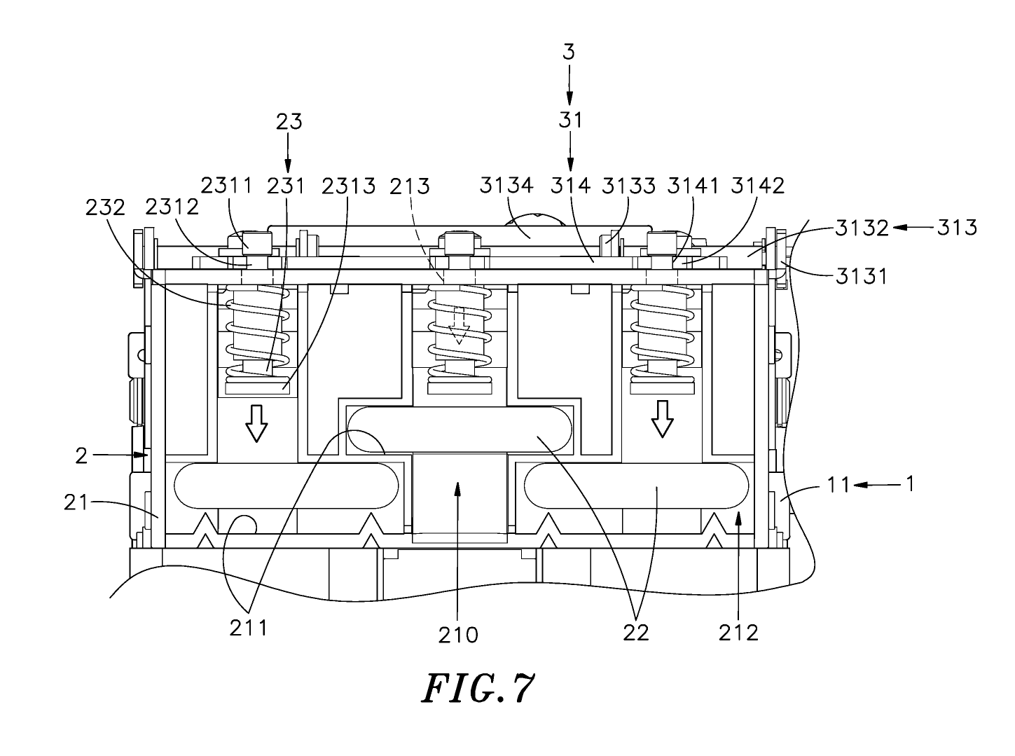

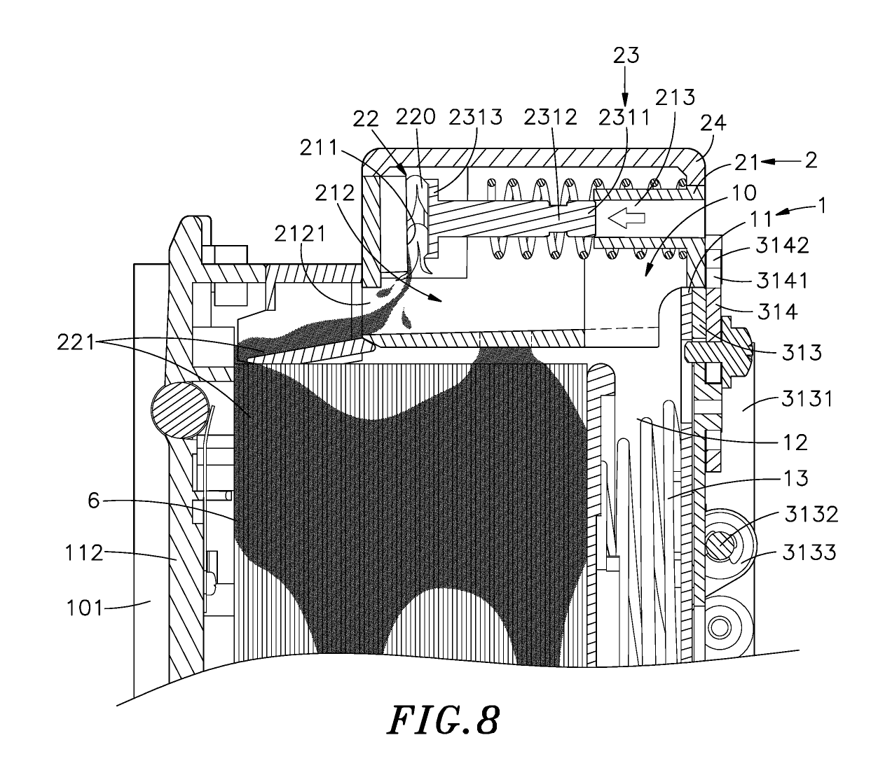

The ink cartridge 2 is mounted in the mounting hole 102 of the box body 11 within the positioning space 140, comprising a cartridge body 21, at least one, for example, multiple ink holders 22, an actuator 23 and a cover plate 24. The cartridge body 21 comprises at least one, for example, multiple storage chambers 211 defined in an inside space 210 thereof for accommodating the respective ink holders 22, an ink outlet 2121 disposed in communication between each the storage chamber 211 and the accommodation chamber 10 of the box body 11, an ink supply channel 212 located at a bottom side of each the storage chamber 211 and connected to the associated ink outlet 2121, and at least one, for example, multiple through holes 213 cut through a peripheral wall thereof and respectively disposed in communication with the storage chambers 211. Each the ink holder 22 comprises an elongated holder body 220 made of glass or a plastic film, and an ink 221 filled in the elongated holder body 220 (see FIG. 7 and FIG. 8).

The actuator 23 is mounted at one lateral side of the cartridge body 21, comprising at least one, for example, multiple impactors (such as firing pin or ejector pin) 231 respectively inserted through the through holes 213 and respectively aimed at the ink holders 22, and a spring 232 mounted around each the impactor 231. Each the impactor 231 comprises a tip 2311 located at one end thereof and suspending outside the cartridge body 21, an expanded impactor head 2313 located at an opposite end thereof and suspending in the one respective storage chamber 211 in the inside space 210 of the cartridge body 21, and a neck 2312 spaced between the tip 2311 and the expanded impactor head 2313 and suspending outside the cartridge body 21 near the associated through hole 213. The spring 232 has one end thereof stopped at an inside wall of the associated storage chamber 211, and an opposite end thereof stopped against the expanded impactor head 2313 of the associated impactor 231. Thus, the spring 232 is movable between a pre-loaded position or a released position. The cover plate 24 is detachably fastened to the cartridge body 21 to close the top open side of the inside space 210.

The anti-theft security module 3 is mounted in the box body 11 within the positioning space 140, comprising a trigger unit 31. The trigger unit 31 comprises a plurality of detection elements 311 symmetrically mounted at the two opposite sidewalls of the box body 11 adjacent to the opening 101, a plurality of links 312 bilaterally and pivotally connected with respective one ends thereof to the detection elements 311, and an interlocking device 313 connected between respective opposite ends of the links 312 and adapted for driving the links 312 to move the detection elements 311 along the transverse sliding grooves 1141 of the mating walls 114. The interlocking device 313 is stopped against an outer surface of the box body 11, comprising two opposite side flanges 3131, a plurality of, for example, two pivot axles 3132 inserted through the two opposite side flanges 3131 with one pivot axle, namely, the upper pivot axle 3132 pivotally connected to the links 312, a plurality of guide rollers 3133 respectively pivotally mounted on the pivot axles 3132 and rotatably kept in contact with the outer surface of the box body 11 for guiding the interlocking device 313 to move vertically relative to the box body 11, and a stopper plate 3134 perpendicularly extended from a middle bottom side thereof.

The trigger unit 31 of the anti-theft security module 3 further comprises a trigger plate 314 and at least one, for example, two tension springs 315. The trigger plate 314 is disposed above the interlocking device 313 adjacent to the actuator 23 of the ink cartridge 2 for linking with the at least one impactor 231, comprising a plurality of retaining notches 3141 spaced along a top edge thereof for engagement with the necks 2312 of the impactors 231 to hold the springs 232 in the pre-loaded position where the trigger plate 314 is prohibited from triggering the actuator 23, and a tapered guide surface 3142 located in each the retaining notch 3141 and expanding gradually toward the outside of the trigger plate 314 for guiding the neck 2312 of the one respective impactor 231 of the actuator 23 into the associated retaining notch 3141. The two tension springs 315 are connected between the other pivot axle, namely, the lower pivot axle 3132 and the box body 11 and adapted for pulling the interlocking device 313 downwards to disengage the trigger plate 314 from the impactors 231 of the actuator 23. Each the tension spring 315 has an end piece 3151 respectively extended from each of two opposite ends thereof and respectively hooked on the lower pivot axle 3132 and a hook (not shown) at the box body 11.

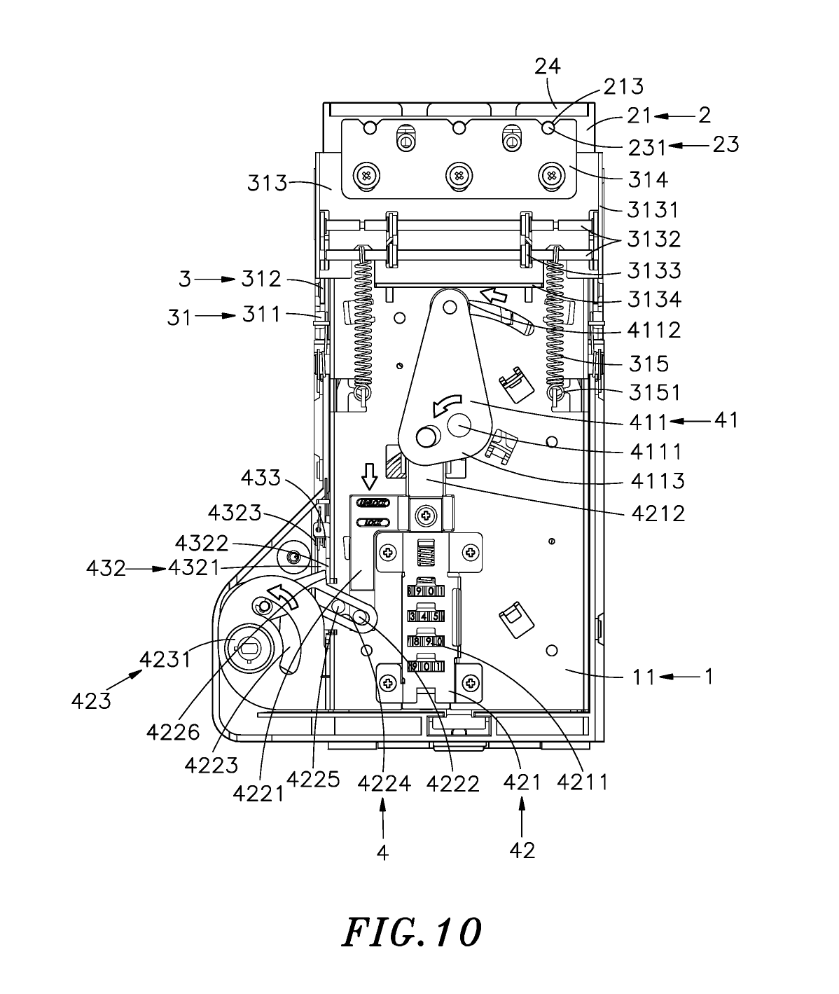

The locking mechanism 4 is mounted on the box body 11 and disposed in the positioning space 140, comprising a control unit 41, an operating unit 42 and a locking unit 43. The control unit 41 comprises a swinging arm 411 pivotally connected to the box body 11 by a pivot pin 4111, a push wheel 4112 rotatably mounted at one end of the swinging arm 411 and adapted for moving the stopper plate 3134 of the interlocking device 313, and a driven portion 4113 located at an opposite end of the swinging arm 411. The operating unit 42 comprises a combination lock 421, an interlocking mechanism 422 and a subsidiary lock 423. The combination lock 421 comprises a series of rotating discs 4211, and a connecting shaft 4212 axially extended through the rotating discs 4211 and pivotally connected to the driven portion 4113 of the swinging arm 411 for turning the swinging arm 411 in direction toward or away from the interlocking device 313. The interlocking mechanism 422 comprises an L-shaped first link 4221 that has one end thereof connected to the connecting shaft 4212 between the rotating disc 4211 and the driven portion 4113 and adapted for moving the connecting shaft 4212 vertically up and down and an opposite end thereof provided with a pivot 4222, a <-shaped second link 4223 that has an elongated position-limiting slot 4224 located at one end thereof and pivotally coupled to the pivot 4222, a pillar 4225 inserted through the elongated position-limiting slot 4224 of the <-shaped second link 4223 in such a manner that the second link 4223 is turnable about the pillar 4225 to move the first link 4221, and a stepped abutment surface 4226 located at one lateral side of a middle part of the second link 4223 adjacent to the elongated position-limiting slot 4224 (see FIG. 10). The subsidiary lock 423 comprises an actuation portion 4231, and a guide plate 4232 pivotally connected to an opposite end of the second link 4223 and drivable by the actuation portion 4231 to move the second link 4223. The locking unit 43 comprises a pinch plate 431 mounted at the guide plate 4232, an anti-trigger baffle plate 432 disposed above the pinch plate 431 and comprising a pushing portion 4321 located at one end thereof and inserted through the through hole 1142 of the mating wall 114, an engagement portion 4322 located at an opposite end thereof and a pivot stud 4323 pivotally located at a middle part thereof, a guide wheel 4311 pivotally mounted on the pinch plate 431 and drivable by the guide plate 4232 to move the pinch plate 431 transversely through the through hole 1142 of the mating wall 114, and a torsion spring 433 mounted around the pivot stud 4323 of the anti-trigger baffle plate 432 with two opposite ends thereof respectively connected to the anti-trigger baffle plate 432 and a hook (not shown) at the box body 11.

The ink-staining anti-theft cash box is mounted in a mainframe 5 of a bill acceptor, automatic vending machine, or service kiosk. The mainframe 5 comprises a housing 51, a receiving unit 52 and a bill presser unit 53. The housing 51 comprises a bill slot (not shown) located in a front side thereof for the insertion of a bill 6, a bill passage 510 backwardly extended from the bill slot, two joining surfaces 5111 respectively formed on two opposite lateral walls 511 thereof, and a retaining groove 512 located on each of the two joining surfaces 5111. Each the retaining groove 512 comprises a transversely extended insertion groove 5121, and an engagement groove 5122 vertically upwardly extended from an inner end of the transversely extended insertion groove 5121. The receiving unit 52 is mounted inside the housing 51 to face toward the bill passage 510. The bill presser unit 53 is mounted in the housing 51 and spaced below the receiving unit 52. The bill presser unit 53 comprises a bill-pressing path 530 vertically disposed at a back side thereof, a transmission roller set 531 drivable by a power drive (not shown) to deliver the inserted bill 6 to the bill-pressing path 530, and a bill pressing-down plate 532 drivable by the power drive through a linkage (not shown) to push the bill 6 from the bill-pressing path 530 toward the opening 101 of the cash box 1.

The aforesaid receiving unit 52 comprises an impression roller set (not shown), an identity recognition device (not shown), a motor (not shown) adapted for driving the impression roller set to deliver the inserted bill 6 along the bill passage 510 to the identify recognition device for recognition. The identify recognition device comprises a sampling and identification module for verifying the authenticity and value of the bill 6, and a plurality of sensors adapted for detecting the inserted bill 6 and controlling the operation of the motor in driving the impression roller set. The mainframe 5 further comprises a power module (not shown) electrically coupled with the receiving unit 52 and the bill presser unit 53. Thus, the mainframe 5 has bill recognizing, receiving and ejecting functions, and is capable of recognizing bills 6 of different materials and sizes issued by different banks or used in different countries. In this embodiment, the bill presser unit 53 is mounted in the housing 51 of the mainframe 5. Alternatively, the bill presser unit 53 can be mounted in the opening 101 of the cash box 1 to face toward the pressure plate 12. Further, the frame-shaped door panel 112 can be pivotally connected to the box body 11 at one side of the opening 101 opposite to the pressure plate 12 to mate with the bill presser unit 53. Since the mainframe 5 is of the known art and its structural design is not within the scope of the claims of the present invention, no further detailed description in this regard will be necessary.

When mounting the cash box 1 in the mainframe 5, attach the box body 11 to the back side of the housing 51 to insert the retaining rods 1131 of the retaining unit 113 into the insertion grooves 5121 of the respective retaining grooves 512 and to abut the mating walls 114 against the joining surfaces 5111 at the two lateral walls 511 of the housing 51, and then move the box body 11 upwards to engage the retaining rods 1131 into the engagement grooves 5122 of the respective retaining grooves 512. Because the actuation portion 4231 of the subsidiary lock 423 of the operating unit 42 of the locking mechanism 4 is exposed to the outside of the shielding shell 14 through the one slot 141 of the shielding shell 14, the user can then insert the key (not shown) through the slot 141 into the actuation portion 4231 and then rotate the key to drive actuation portion 4231, forcing the guide plate 4232 to move the guide wheel 4311 of the locking unit 43 and causing the pinch plate 431 to be moved through the one through hole 1142 in the associated mating wall 114. At this time, the pinch plate 431 is engaged into the insertion groove 5121 of the retaining groove 512 to lock the box body 11 to the housing 51. Because the pinch plate 431 of the locking unit 43 is linked to the subsidiary lock 423 of the operating unit 42, the invention prevents the site manager from dismounting the cash box 1 without unlocking the locking unit 43 to cause a false triggering of the anti-theft security module 3 and also relatively increases the difficulty in stealing the cash box 1.

After installation of the cash box 1 in the mainframe 5, the mating walls 114 of the box body 11 are abutted against the joining surfaces 5111 at the two lateral walls 511 of the housing 51 to let the detection elements 311 of the trigger unit 31 of the anti-theft security module 3 be stopped by the joining surfaces 5111, the links 312 are forced against the pivot axles 3132 of the interlocking device 313, and the interlocking device 313 is stopped from being pulled by the tension springs 315, and thus, the trigger plate 314 is prohibited from escaping out of the impactors 231 of the actuator 23 of the ink cartridge 2, preventing the actuator 23 from falsely triggering the ink holders 22. Further, by means of operating the operating unit 42 of the locking mechanism 4 to drive the locking unit 43 in forcing the pinch plate 431 into engagement with the retaining groove 512 of the housing 51, the swinging arm 411 of the control unit 41 is moved away from the interlocking device 313 of the trigger unit 31 to enable the anti-theft function of the anti-theft security module 3. Further, subject to the design of the opening direction of the frame-shaped door panel 112 of the box body 11 of the cash box 1 and the mounting relationship between the mating walls 114 and the mainframe 5 and the function of the shielding shell 14 that surrounds the box body 11 to keep the ink cartridge 2, the anti-theft security module 3 and the locking mechanism 4 from sight, the cash box 1 has no apparent outer weakness, increasing the difficulty in stealing or destroying the cash box 1 and providing enhanced security.

When a user inserts the bill 6 through the bill slot of the housing 51 of the mainframe 5 into the bill passage 510, the receiving unit 52 will carry the inserted bill 6 to the bill presser unit 53, enabling the bill 6 to be delivered by the transmission roller set 531 to the bill-pressing path 530 and then pushed by the bill pressing-down plate 532 through the frame-shaped door panel 112 of the box body 11 onto the pressure plate 12 so that the bill 6 can be further forced into the accommodation chamber 10 inside the box body 11 subject to the relative motion between the elastic members 13 and the pressure plate 12. When the bill pressing-down plate 532 is returned to its original position, the elastic restoring energy of the elastic members 13 forces the pressure plate 12 to hold down the bill 6 between the pressure plate 12 and the frame-shaped door panel 112. Thus, when this operating procedure is repeated again and again, a large amount of the bills 6 can be received in a stack in the accommodation chamber 10 of the box body 11 in a good order.

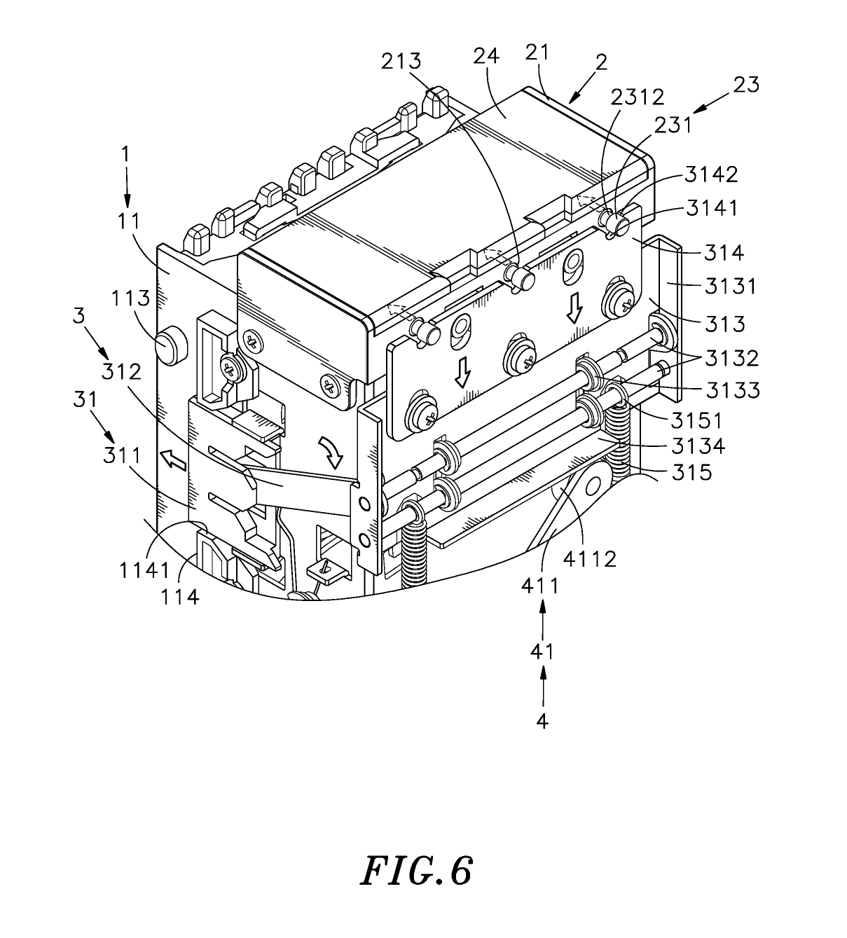

Please refer also to FIGS. 6, 7 and 8, where FIG. 6 is an elevational view of a part of the present invention, illustrating the anti-theft security module triggered after removal of the ink-staining anti-theft cash box from the mainframe; FIG. 7 is a schematic top view of a part of the present invention, illustrating a status of the ink cartridge before ink injection; FIG. 8 is a schematic sectional side view of a part of the present invention, illustrating an ink ejected out of the ink cartridge onto the storage bills.

If a criminal destroys the cash box 1 or removes it from the mainframe 5 without unlocking the locking mechanism 4, the mating walls 114 of the box body 11 will be separated from the joining surfaces 5111 of the lateral walls 511 of the housing 51 of the mainframe 5. At this time, the detection elements 311 of the trigger unit 31 of the anti-theft security module 3 will be triggered, enabling the tension springs 315 to pull the interlocking device 313 downwardly toward the swinging arm 411 of the control unit 41, and the links 312 will be moved with the interlocking device 313, causing movement of the detection elements 311 along the respective transverse sliding grooves 1141 toward the outside of the mating walls 114 and separation of the trigger plate 314 from the impactors 231 of the actuator 23 of the ink cartridge 2. After separation between the retaining notches 3141 of the trigger plate 314 and the necks 2312 of the impactors 231, the impactors 231 will be immediately forced by the associated springs 232 to pierce the expanded impactor heads 2313 thereof into the elongated holder bodies 220 of the respective ink holders 22 in the cartridge body 21 or to lacerate the elongated holder bodies 220 of the respective ink holders 22 with the expanded impactor heads 2313, causing the ink 221 to be ejected out of the respective ink holders 22 through the ink supply channels 212 and the ink outlet 2121 toward the inside of the accommodation chamber 10 of the box body 11 to ink-stain the storage bills 6 over at least one corner of each the storage bill 6, causing the storage bills 6 to lose their market value or transaction capabilities, deterring criminals to limit their criminal acts and reducing the risk of theft.

Subject to the design that the elongated holder bodies 220 of the ink holders 22 are made of glass or a plastic film, the characteristic that the ink holders 22 in the storage chambers 211 inside the cartridge body 21 are replaceable and the characteristic that the impactors 231 and the springs 232 of the actuator 23 are installed to mate with the trigger plate 314 of the trigger unit 31, the anti-theft function of the anti-theft security module 3 can be reset. Further, the ink outlets 2121 of the three ink supply channels 212 of the cartridge body 21 of the ink cartridge 2 are arranged in a staggered manner so that the ink 221 of the ink holders 22 can be evenly ejected over any amount of the storage bills 6 in the box body 11 to ink-stain at least one corner of each the storage bill 6. The ink 221 can be an unfading red, blue or green ink. When the bill 6 is stained with this kind of the unfading ink 221, people, companies and banks can easily recognize the bill 6 is ink-stained and can refuse to accept the ink-stained bill 6, and thus, the ink-stained bill 6 will lose its market value or transaction function and will not be allowed to circulate in the market. People receiving the ink-stained bill 6 can simply bring it to a particular financial institution or authorized security authority for the exchange of an equivalent of money. Further, a security authority can trace the history of the ink-stained bill 6, assisting the police to effectively detect the burglary.

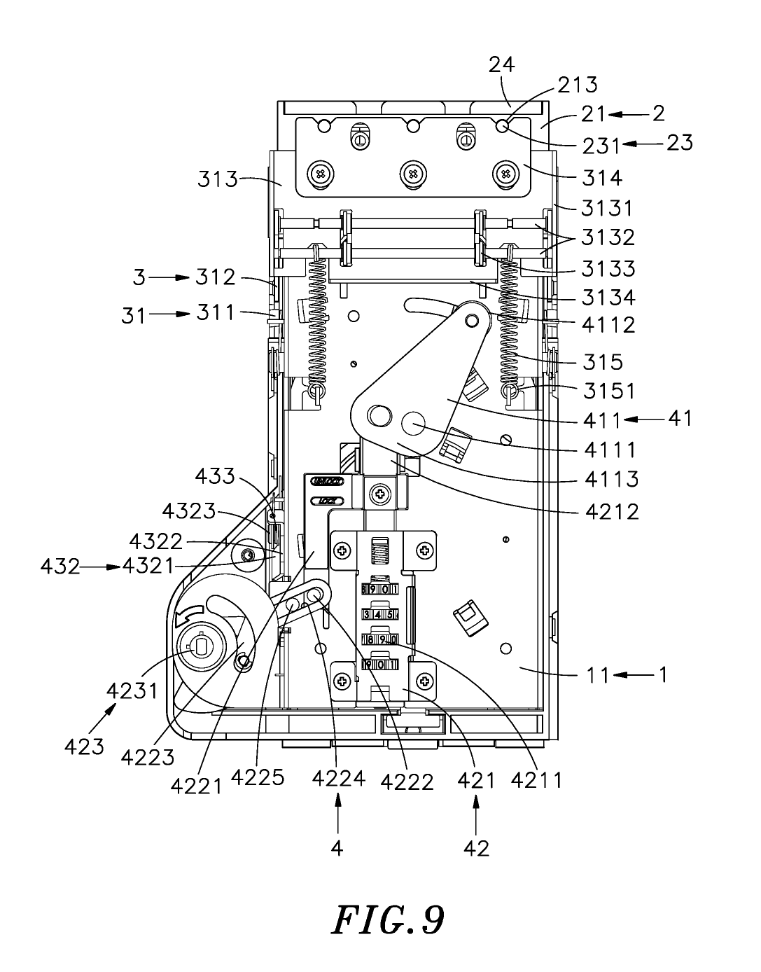

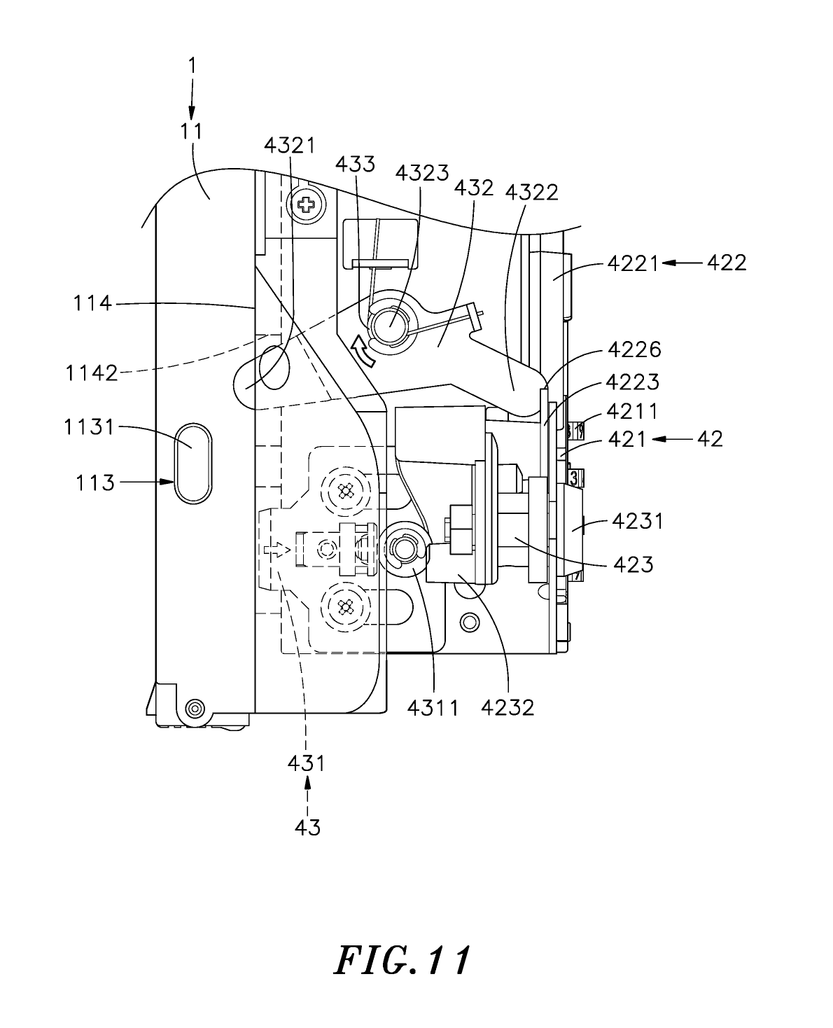

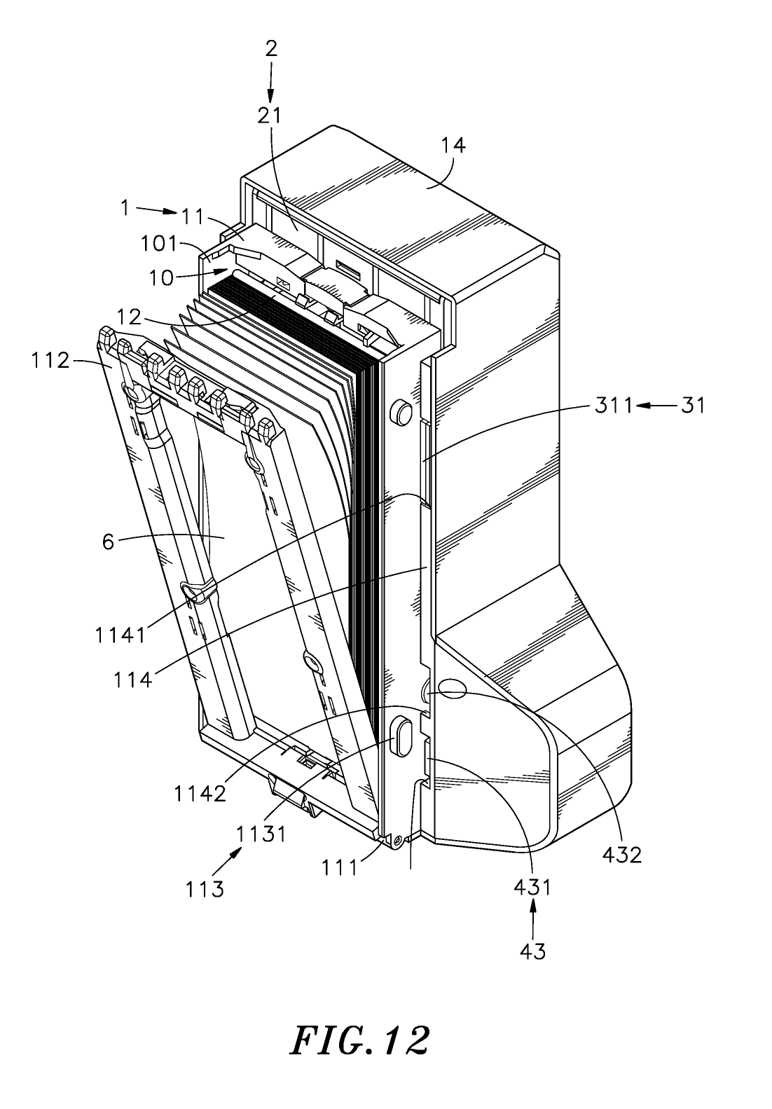

Please refer also to FIGS. 9, 10, 11 and 12, where FIG. 9 is a schematic front view illustrating a status of the cash box before unlocking; FIG. 10 is a schematic front view illustrating a status of the cash box during the unlocking operation; FIG. 11 is a schematic side view illustrating the cash box unlocked. As illustrated, when the site manager is going to unlock the cash box 1 or to remove the cash box 1 from the mainframe 5, the site manager needs to unlock the combination lock 421 of the operating unit 42 of the locking mechanism 4 at first, and then to rotate the rotating discs 4211 of the combination lock 421 in the slots 141 of the shielding shell 14 to show the correct combination. Because the connecting shaft 4212 of the combination lock 421 is controlled by the interlocking mechanism 422 and the subsidiary lock 423, it is necessary to unlock the combination lock 421 and then to unlock the subsidiary lock 423 so that the operating unit 42 can be operated to move the swinging arm 411 of the control unit 41 into abutment against or away from the interlocking device 313 of the trigger unit 31 of the anti-theft security module 3, achieving locking or unlocking.

When unlocking the subsidiary lock 423 of the operating unit 42, insert the key (not shown) into the actuation portion 4231 and then drive the key to rotate the actuation portion 4231 counter-clockwise, causing the guide plate 4232 to be moved with the actuation portion 4231. At this time, the second link 4223 of the interlocking mechanism 422 is turned upwardly about the pillar 4225 in the elongated position-limiting slot 4224, causing the peripheral edge of the elongated position-limiting slot 4224 to force the pivot 4222 of the first link 4221 downwards and simultaneously causing the connecting shaft 4212 of the combination lock 421 to move the driven portion 4113 of the swinging arm 411 of the control unit 41 downwards. Thereafter, the swinging arm 411 is turned upwardly about the pivot pin 4111 to move the push wheel 4112 into abutment against the stopper plate 3134 of the interlocking device 313, prohibiting the tension springs 315 from pulling the interlocking device 313 and preventing disengagement of the trigger plate 314 from the impactors 231 of the actuator 23 to trigger the ink holders 22 of the ink cartridge 2 in ejecting the ink. On the contrary, if the subsidiary lock 423 is locked, the swinging arm 411 of the control unit 41 will be forced by the operating unit 42 to move away from the interlocking device 313 of the trigger unit 31, allowing the trigger plate 314 to be pulled downwards away from the impactors 231 of the actuator 23 by the tension springs 315, and thus, the ink holders 22 will be triggered to eject the ink.

During the process of unlocking the subsidiary lock 4231 of the operating unit 42, the actuation portion 4231 drives the guide plate 4232 to bias through a predetermined angle, causing the guide wheel 4311 of the pinch plate 431 of the locking unit 43 to move along the guide plate 4232 backwardly to the original position. As soon as the pinch plate 431 is disengaged from the retaining groove 512 of the housing 51, the unlocked state is achieved. At this time, the retaining unit 113 of the box body 11 can be moved out of the retaining grooves 512 of the housing 51, allowing separation between the cash box 1 and the mainframe 5. At this time, the site manager can open the frame-shaped door panel 112 from the box body 11 of the cash box 1 in the direction same as the direction in mounting the mating walls 114 in the mainframe 5, and then take the storage bills 6 out of the box body 11.

When the site manager removes the cash box 1 from the mainframe 5 after unlocked the locking mechanism 4, the pushing portion 4321 of the anti-trigger baffle plate 432 of the locking unit 43 is released from the constraint of the joining surfaces 5111 of the lateral walls 511 of the housing 51 and driven by the torsion spring 433 to turn about the pivot stud 4323 out of the through hole 1142 of the mating wall 114 of the box body 11, and the engagement portion 4322 of the anti-trigger baffle plate 432 is biased downwardly to a lower limit position. When locking the subsidiary lock 423 at this time, the second link 4223 of the interlocking mechanism 422 will be moved to abut the stepped abutment surface 4226 against the engagement portion 4322 of the anti-trigger baffle plate 432 and to prohibit the subsidiary lock 423 from being locked, avoiding locking the operating unit 42 to trigger the anti-theft security module 3 as the site manager is taking the cash box 1 out of the mainframe 5 and preventing a false triggering of the ink cartridge 2 to ink-stain the storage bills 6 in the cash box 1. On the contrary, when the cash box 1 is mounted in the mainframe 5, the pushing portion 4321 of the anti-trigger baffle plate 432 will be stopped against the joining surface 5111 of the associated lateral wall 511 of the housing 51 and moved back to its original position to keep the engagement portion 4322 away from the second link 4223 of the interlocking mechanism 422. At this time, the subsidiary lock 423 can be locked, allowing operation of the operating unit 42 to move the control unit 41 in enabling the anti-theft function of the anti-theft security module 3.

Further, as stated above, the trigger unit 31 of the anti-theft security module 3 mates with the ink ejection functioning of the actuator 23 of the ink cartridge 2; the operating unit 42 of the locking mechanism 4 is operable to move the control unit 41 in enabling the anti-theft function of the trigger unit 31 of the anti-theft security module 3; the locking unit 43 enhances the anti-theft and anti-destruction strength of the cash box 1 after installation of the cash box 1 in the mainframe 5; linking between the combination lock 421 and the subsidiary lock 423 of the operating unit 42 for allowing removal of the cash box 1 from the mainframe 5 requires an unlocking operation and the use of a key. All the aforesaid characteristics of the present invention significantly increase the difficulty in stealing the cash box 1. If the cash box 1 is separated from the mainframe 5 without unlocking the locking mechanism 4 according to the normal unlocking procedure, the anti-theft security module 3 will trigger the ink holders 22 of the ink cartridge 2 to ink-stain the storage bills 6 in the cash box 1 with the unfading ink 221, causing the storage bills 6 to lose their market value or transaction capabilities, deterring criminals to limit their criminal acts and reducing the risk of theft.

The functioning of the trigger unit 31 of the anti-theft security module 3 to detect separation of the cash box 1 from the mainframe 5 is achieved by: initiating triggering when the detection elements 311 (for example, sliding blocks) are released from the constraint of the housing 51. When triggered, the tension springs 315 are released to pull the interlocking device 313 and to further force the links 312 in moving the trigger plate 314 away from the impactors 231 of the actuator 23 of the ink cartridge 2, the impactor 231. Immediately after separation of the trigger plate 314 from the impactors 231 of the actuator 23, the impactors 231 are pulled by the springs 232 to strike against or to pierce into the respective ink holders 22, triggering the ink holders 22 mechanically to ink-stain the storage bills 6 in the cash box 1 with the unfading ink 221. In actual application, the trigger unit 31 of the anti-theft security module 3 can use any of a variety of sensors (such as displacement sensors, pressure sensors, etc.) for triggering the actuator 23 (such as ink jet head, air pump, motor-driven linkage, gear mechanism or solenoid valve controlled cylinder) to force the respective ink holders 22 in ink-staining the storage bills 6 in the cash box 1 upon detection of separation between the cash box 1 and the mainframe 5. Further, the control unit 41 of the locking mechanism 4 can be a mechanical or electromagnetic switch (such as key switch, relay, toggle switch, transistor or diode switch, etc.), enabling the operating unit 42 to electronically control the locking or unlocking operation of the trigger unit 31 of the anti-theft security module 3. Therefore, any other equivalent measures capable of controlling the anti-theft security module 3 to trigger the ink cartridge 2 and the locking mechanism 4 to enable or disable the anti-theft security module 3 can be selectively used and should be included within the scope of the present invention.

In conclusion, the invention provides an ink-staining anti-theft cash box comprises a cash box 1, which is mounted in a mainframe 5 of a bill acceptor, automatic vending machine, or service kiosk and which comprises a box body 11 defining an accommodation chamber 10, a front opening 101 and a top mounting hole 102, a ink cartridge 2, which is mounted in the top mounting hole 102 and which comprises a cartridge body 21, a plurality of ink holders 22 accommodated in the cartridge body 21 and an actuator 23 adapted for triggering the ink holders 22, an anti-theft security module 3 with a trigger unit 31 mounted in the box body 11, and a locking mechanism 4, which comprises a control unit 41 and an operating unit 42 operable to drive the control unit 41 in locking or unlocking the trigger unit 31. If the cash box 1 is removed from the mainframe 5 by force without unlocking the locking mechanism 4 according to the normal unlocking procedure, the trigger unit 31 of the anti-theft security module 3 will trigger the actuator 23 of the ink cartridge 2, forcing the respective ink holders 22 to ink-stain the storage bills 6 in the box body 11 with an unfading ink 221, causing the bills 6 to lose their market value or transaction capabilities, deterring criminals to limit their criminal acts and enhancing the security level of the cash box 1.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An ink-staining anti-theft cash box mounted in a housing of a mainframe of an apparatus for receiving each bill being delivered from a bill passage in said housing and pressed by a bill presser unit of said mainframe, said ink-staining anti-theft cash box comprising a cash box, an ink cartridge, an anti-theft security module and a locking mechanism, wherein:
said cash box comprises a box body detachably mountable to a joining surfaces of said housing of said mainframe, said box body comprising an accommodation chamber, an opening defined in a front side thereof in communication with said accommodation chamber and facing toward said bill presser unit of said mainframe and a mounting hole located in a top side thereof in communication with said accommodation chamber, and a pressure plate movably mounted in said accommodation chamber and adapted for bearing each said bill being received from said mainframe;
said ink cartridge is mounted in said mounting hole of said box body, comprising a cartridge body, at least one ink holder accommodated in said cartridge body, and an actuator controllable to cause said at least one ink holder to eject an unfading ink onto each said bill that is received in said box body;
said anti-theft security module is mounted in said box body, comprising a trigger unit disposed adjacent to said opening of said box body opening for detecting separation of said cash box from said joining surfaces of said housing of said mainframe and triggering said actuator of said ink cartridge to cause said at least one ink holder to eject said unfading ink;
said locking mechanism is mounted in said box body, comprising a control unit and an operating unit operable to drive said control unit to enable said trigger unit of said anti-theft security module in such a manner that if said locking mechanism is not unlocked according to the normal unlocking procedure and said cash box is separated from said housing of said mainframe by force, said anti-theft security module is enabled to trigger said ink cartridge, causing said at least one ink holder to ink-stain each said bill in said box body with said unfading ink.

2. The ink-staining anti-theft cash box as claimed in claim 1, wherein said box body of said cash box further comprises an axle transversely disposed in a bottom side of said opening, and a frame-shaped door panel pivotally coupled to said axle for stopping said pressure plate in place and movable to close or open said opening, the direction in opening said frame-shaped door panel from said opening being same as the direction in mounting said cash box in said housing of said mainframe for allowing said bill presser unit to press each said bill through said frame-shaped door panel into the inside of said box body.

3. The ink-staining anti-theft cash box as claimed in claim 1, wherein said box body of said cash box further comprises a retaining unit, said retaining unit comprising a plurality of retaining rods vertically spaced along two opposite lateral sides of said opening, and two mating walls respectively extended from two opposite sidewalls of said box body adjacent to said retaining unit for abutment against said joining surfaces of said housing of said mainframe and engagement with a retaining groove in each said joining surface of said mainframe.

4. The ink-staining anti-theft cash box as claimed in claim 3, wherein each said retaining groove of said mainframe comprises a transversely extended insertion groove for receiving one respective said retaining rod of said retaining unit and an engagement groove vertically upwardly extended from an inner end of said transversely extended insertion groove for the engagement of the respective said retaining rod of said retaining unit; said operating unit of said locking mechanism comprises a subsidiary lock, said subsidiary lock comprising an actuation portion and a guide plate movable by said actuation portion; said locking mechanism further comprises a locking unit, said locking unit comprising a pinch plate mounted at said guide plate of said subsidiary lock, and a guide wheel pivotally mounted on said pinch plate and drivable by said guide plate to move said pinch plate transversely through one respective said mating wall into the said transversely extended insertion groove of the respective said retaining groove of said mainframe.

5. The ink-staining anti-theft cash box as claimed in claim 3, wherein each said mating wall of said cash box defines therein a transverse sliding groove; said actuator of said ink cartridge comprises at least one impactor respectively facing toward said at least one ink holder; said trigger unit of said anti-theft security module comprises a plurality of detection elements symmetrically mounted at two opposite sidewalls of said box body adjacent to said opening and stoppable by said joining surfaces of said housing of said mainframe, a plurality of links bilaterally and pivotally connected with respective one ends thereof to said detection elements, an interlocking device connected between respective opposite ends of said links and adapted for driving said links to move said detection elements along said transverse sliding grooves of said mating walls, a trigger plate for engagement with said actuator, and at least one tension spring for pulling said trigger plate away from said actuator for enabling said at least one impactor to force said at least one ink holder to eject said unfading ink when said detection elements are released from the constraint of said joining surfaces.

6. The ink-staining anti-theft cash box as claimed in claim 5, wherein said cartridge body of said ink cartridge comprises an inside space, at least one storage chamber defined in said inside space for accommodating said at least one ink holder respectively, an ink supply channel defined in a bottom said of each said storage chamber and disposed in communication with said accommodation chamber of said box body, and at least one through hole cut through a peripheral wall thereof and respectively disposed in communication with said at least one storage chamber; said at least one impactor of said actuator is inserted through said at least one through hole of said ink cartridge; said actuator further comprises at least one spring respectively mounted on said at least one impactor and adapted for holding said at least one impactor in a pre-loaded position where said trigger plate is prohibited from triggering said actuator such that when said trigger plate of said anti-theft security module is disengaged from said at least one impactor, said at least one spring of said actuator are released from the constraint and to force said at least one impactor against said at least one ink holder, enabling said unfading ink to be ejected through said at least one ink supply channel into said box body to ink-stain each said bill in said box body.

7. The ink-staining anti-theft cash box as claimed in claim 6, wherein each said impactor of said actuator comprises a tip located at one end thereof and suspending outside said cartridge body, an expanded impactor head located at an opposite end thereof and suspending in one said storage chamber of said cartridge body, and a neck spaced between said tip and said expanded impactor head and suspending outside said cartridge body near the associated said through hole of said cartridge body; each said spring of said actuator has one end thereof stopped at an inside wall of the associated said storage chamber, and an opposite end thereof stopped against the said expanded impactor head of the associated said impactor; said trigger plate of said trigger unit comprises at least one retaining notch for engaging the said neck of each said impactor to hold the associated said spring of said actuator in said pre-loaded position.

8. The ink-staining anti-theft cash box as claimed in claim 5, wherein said interlocking device of said anti-theft security module comprises two opposite side flanges, an upper pivot axle and a lower pivot axle respectively inserted through said side flange, said upper pivot axle being pivotally connected to said links of said trigger unit, a plurality of guide rollers respectively pivotally mounted on said upper pivot axle and said lower pivot axle and rotatably kept in contact with said box body for guiding said interlocking device to move vertically relative to said box body, and a stopper plate perpendicularly extended from a middle bottom side thereof; said tension springs of said trigger unit are connected between said lower pivot axle and said box body and adapted for pulling said interlocking device downwards to disengage said trigger plate from said at least one impactor of said actuator.

9. The ink-staining anti-theft cash box as claimed in claim 3, wherein said cash box further comprises a metal shielding shell fixedly fastened to said mating walls of said box body to surround said box body with a positioning space defined between said metal shielding shell and said box body for accommodating said ink cartridge, said anti-theft security module and said locking mechanism.

10. The ink-staining anti-theft cash box as claimed in claim 1, wherein said metal shielding shell of said cash box comprises a plurality of slots; said operating unit of said locking mechanism comprises a combination lock, an interlocking mechanism and a subsidiary lock, said combination lock and said subsidiary lock each comprising a series of rotating discs respectively and partially protruding out of said slots of said metal shielding shell and an actuation portion rotatable with a respective key.

11. The ink-staining anti-theft cash box as claimed in claim 1, wherein said cash box further comprises a plurality of elastic members mounted in a bottom side of said accommodation chamber of said box body and stopped against said pressure plate for forcing said pressure plate toward said opening of said box body of said cash box; said mainframe further comprises a receiving unit mounted inside said housing to face toward said bill passage for receiving each inserted said bill from said bill passage; said bill presser unit is mounted in said housing and spaced below said receiving unit bill presser unit, comprising a bill-pressing path vertically disposed at a back side thereof, a transmission roller set adapted for delivering each inserted said bill to said bill-pressing path and a bill pressing-down plate adapted for pushing each inserted said bill from said bill-pressing path toward said opening of said cash box.

12. The ink-staining anti-theft cash box as claimed in claim 1, wherein each said ink holder of said ink cartridge comprises an elongated holder body selectively made of glass or a plastic film and filled up with said unfading ink and drivable by said actuator to eject said unfading ink toward the inside of said box body; said ink cartridge further comprises a cover plate detachably fastened to said cartridge body to hold said at least one ink holder inside said cartridge body.

13. The ink-staining anti-theft cash box as claimed in claim 1, wherein said actuator of said ink cartridge comprises at least one impactor respectively facing toward said at least one ink holder;
said trigger unit of said anti-theft security module comprises a plurality of detection elements symmetrically mounted at two opposite sidewalls of said box body adjacent to said opening and stoppable by said joining surfaces of said housing of said mainframe, a plurality of links bilaterally and pivotally connected with respective one ends thereof to said detection elements, an interlocking device connected between respective opposite ends of said links and adapted for driving said links to move said detection elements along said transverse sliding grooves of said mating walls, a trigger plate for engagement with said actuator, and at least one tension spring for pulling said trigger plate away from said actuator for enabling said at least one impactor to force said at least one ink holder to eject said unfading ink when said detection elements are released from the constraint of said joining surfaces; said control unit of said locking mechanism comprises a swinging arm pivotally connected to said box body by a pivot pin, a push wheel rotatably mounted at one end of said swinging arm and adapted for moving said stopper plate of said interlocking device, and a driven portion located at an opposite end of said swinging arm and adapted for turning said swinging arm toward or away from said interlocking device for locking or unlocking said locking mechanism

14. The ink-staining anti-theft cash box as claimed in claim 13, wherein said operating unit of said locking mechanism comprises a combination lock and subsidiary lock, said combination lock comprising a series of rotating discs, and a connecting shaft axially extended through said rotating discs and pivotally connected to said driven portion of said swinging arm for turning said swinging arm in direction toward or away from said interlocking device, said subsidiary lock comprising an actuation portion and a guide plate pivotally connected to said interlocking mechanism drivable by said actuation portion to move said swinging arm toward or away from said interlocking device.

15. The ink-staining anti-theft cash box as claimed in claim 14, wherein said interlocking mechanism comprises a first link, said first link having one end thereof connected to said connecting shaft of said combination lock and an opposite end thereof provided with a pivot, a second link, said second link comprising an elongated position-limiting slot located at one end thereof and pivotally coupled to said pivot of said first link, and a pillar inserted through said elongated position-limiting slot of said second link for allowing said second link to be turned about said pillar to move said first link.

16. The ink-staining anti-theft cash box as claimed in claim 15, wherein said locking mechanism further comprises a locking unit, said locking unit comprising a pinch plate mounted at said guide plate of said subsidiary lock, an anti-trigger baffle plate disposed above the pinch plate, a guide wheel pivotally mounted on said pinch plate and drivable by said guide plate to move said pinch plate transversely through one respective said mating wall into the said transversely extended insertion groove of the respective said retaining groove of said mainframe, said anti-trigger baffle plate comprising a pushing portion located at one end thereof and stoppable by one said joining surface of said housing of said mainframe, an engagement portion located at an opposite end thereof and a pivot stud pivotally located at a middle part thereof, and a torsion spring mounted around said pivot stud of said anti-trigger baffle plate with two opposite ends thereof respectively connected to said anti-trigger baffle plate and said box body; said interlocking mechanism further comprises a stepped abutment surface located at one lateral side of a middle part of said second link adjacent to said elongated position-limiting slot for abutting against said box body.
